(19) United States
(12) Patent Application Publication
(10) Pub. No.: US 2004/0252355 A1
(43) Pub. Date: Dec. 16, 2004

(54) Flatbed scanner, automatic document feeder and duplex scanner including both of them

(76) Inventor: Michael Chen, Hsin Chu City (TW)

Correspondence Address: BIRCH STEWART KOLASCH & BIRCH, PO BOX 747, FALLS CHURCH, VA, 22040-0747, US

(21) Appl. No.: 10/681,123

(22) Filed: Oct. 9, 2003

(30) Foreign Application Priority Data
Jun. 13, 2003 (TW) 092210796

(51) Int. Cl. G06K 9/00; H04N 1/04

(52) U.S. Cl. 358/497; 358/494; 382/318

(57) ABSTRACT

A duplex scanner includes an automatic document feeder (ADF) and a flatbed scanner. Each of the ADF and the flatbed scanner includes a scan module for scanning a front side image and a back side image of a document. The ADF scans the back side image of the document and converts the scanned analog signal into a digital signal. The flatbed scanner receives the digital signal from the ADF, simultaneously scans the front side image of the document, and converts the scanned analog signal into a digital signal for output.

### BACKGROUND OF THE INVENTION

1. Field of the Invention

The invention relates to a flatbed scanner, an automatic document feeder and a duplex scanner including both of them, and more particularly to a flatbed scanner with reduced cost, an automatic document feeder in combination with the flatbed scanner, and a duplex scanner including both of them.

2. Description of the Related Art

Conventionally, duplex document scan operations are usually performed to simultaneously scan a front side image and a back side image of a document using two scan modules. The two scan modules are mounted to a flatbed scanner and an automatic document feeder having the scan function, respectively. The original scan data from the two scan modules must be transferred to the processing circuit of the flatbed scanner, in which the scan data is processed. For example, the scan data may be converted from an analog signal into a digital signal, which may be amplified.

Typically, the manufacturer may design the flatbed scanner with optional functions. In other words, a user may simply buy the flatbed scanner to only enjoy the flatbed scan function. When the user needs to scan many simplex documents, he or she can buy an automatic document feeder and combine it with the flatbed scanner. Alternatively, when the user needs to scan many duplex documents, he or she can buy an automatic document feeder having the scan function and combine it with the flatbed scanner.

However, the conventional flatbed scanner, which may be used in combination with the automatic document feeder having the scan function, usually has all processing and control circuits, memories, and the like, to process the scan signal from both of the automatic document feeder and the flatbed scanner. Thus, the automatic document feeder only has to transfer the analog signal from its scan module to the flatbed scanner for processing the analog signal.

In addition, the scan operation of the automatic document feeder is also controlled by the processing and control circuits of the flatbed scanner. Consequently, hardware devices for the automatic document feeder have to be left in advance, thereby making the price of the flatbed scanner relatively high. Furthermore, the user cannot economically purchase the flatbed scanner and the automatic document feeder in different stages according to different requirements.

### SUMMARY OF THE INVENTION

It is therefore an object of the invention to provide a cheap flatbed scanner, which may be used in combination with an automatic document feeder having the scan function to become a duplex scanner.

To achieve the above-mentioned object, the invention provides a flatbed scanner, which may be used in combination with an automatic document feeder having the scan function, to simultaneously scan a front side image and a back side image of a document. The flatbed scanner includes a bottom image-reading module for reading the front side image to obtain an analog front-side signal, a bottom motor for moving the bottom image-reading module, a bottom circuit for controlling the bottom image-reading module and converting the analog front-side signal into a digital front-side signal, and a bottom memory connected to the bottom circuit. The bottom circuit includes a digital signal receiver for receiving a digital back-side signal, which corresponds to the back side image, from the automatic document feeder.

Furthermore, the invention also provides an automatic document feeder, which may be used in combination with a flatbed scanner, to simultaneously scan a back side image and a front side image of a document. The automatic document feeder includes a top image-reading module for reading the back side image to obtain an analog back-side signal, a sheet-feeding mechanism for feeding the document, and a top circuit for receiving the analog back-side signal and converting the analog back-side signal into a digital back-side signal for output to the flatbed scanner.

In addition, the invention also provides a duplex scanner including the above-mentioned automatic document feeder and flatbed scanner. Thus, the cost of the flatbed scanner can be effectively reduced.

### BRIEF DESCRIPTION OF THE DRAWINGS

FIG. 1 is a block diagram showing a duplex scanner according to a first embodiment of the invention.

FIG. 2 is a block diagram showing a duplex scanner according to a second embodiment of the invention.

FIG. 3 is a block diagram showing a duplex scanner according to a third embodiment of the invention.

### DETAILED DESCRIPTION OF THE INVENTION

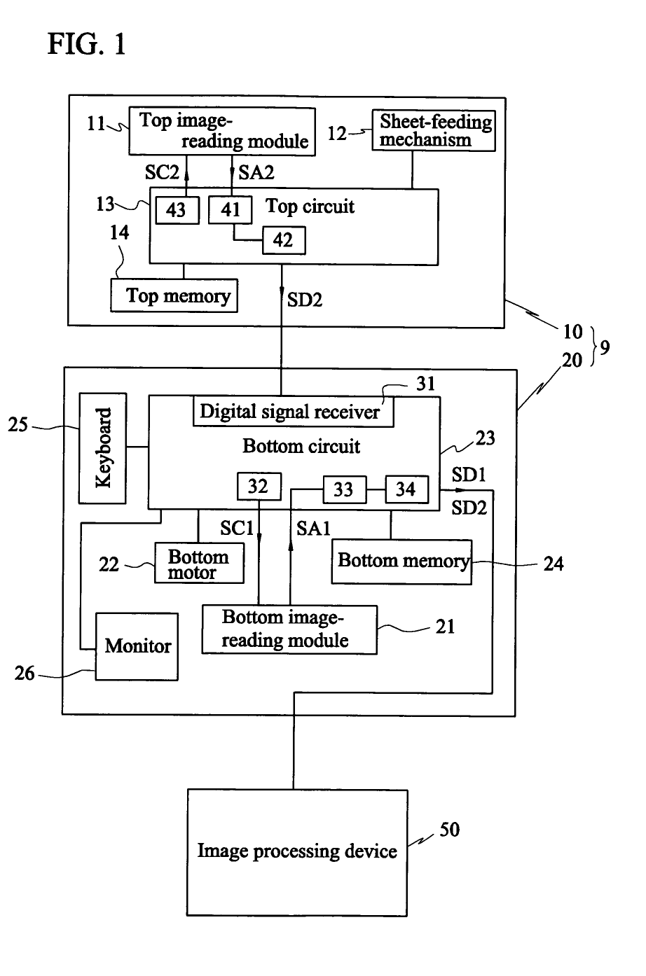

FIG. 1 is a block diagram showing a duplex scanner according to a first embodiment of the invention. As shown in FIG. 1, a duplex scanner 9 of the invention may simultaneously scan a front side image and a back side image of a document, and the scanned results usually may be sent to an image processing device 50 such as a computer, a printing device, or the like. The duplex scanner 9 is composed of an automatic document feeder 10 and a flatbed scanner 20.

The automatic document feeder 10 includes a top image-reading module 11, a sheet-feeding mechanism 12 for feeding the document, a top circuit 13, and a top memory 14. The top image-reading module 11 is utilized to read the back side image to obtain an analog back-side signal SA2 for output. The top circuit 13 is utilized to control the top image-reading module 11, and convert the analog back-side signal SA2 into a digital back-side signal SD2 for output to the flatbed scanner 20. The top memory 14 is connected to the top circuit 13 to store data and serve as a buffer.

The top circuit 13 includes a clock generator 43 for generating a top clock signal SC2 to control the image reading operation of the top image-reading module 11, and an analog-to-digital converter 41 and an amplifier 42 for converting and amplifying the analog back-side signal SA2 into the digital back- side signal SD2, respectively. The digital back-side signal SD2 also may be otherwise processed by the top circuit 13.

The flatbed scanner 20 includes a bottom image-reading module 21, a bottom motor 22, a bottom circuit 23, a bottom memory 24, a keyboard 25, and a monitor 26. The bottom image-reading module 21 is utilized to read the front side image to obtain an analog front-side signal SA1. The bottom motor 22 is utilized to move the bottom image-reading module 21. The bottom circuit 23 is utilized to receive the analog front-side signal SA1 and convert the analog front-side signal SA1 into a digital front-side signal SD1 for output to the image processing device 50. Simultaneously, the digital back-side signal SD2 is also output to the image processing device 50 through the flatbed scanner 20. The bottom memory 24 is connected to the bottom circuit 23 to store data and serve as a buffer. The user may control the operations of the duplex scanner 9 through the keyboard 25. The monitor 26 may display the state of the flatbed scanner 20.

The bottom circuit 23 includes a digital signal receiver 31 for receiving the digital back-side signal SD2, which corresponds to the back side image and comes from the automatic document feeder 10.

The bottom circuit 23 further includes a clock generator 32 for generating a bottom clock signal SC1 to control the bottom image-reading module 21, and an analog-to-digital converter 33 and an amplifier 34 for converting and amplifying the analog front-side signal SA1 into the digital front-side signal SD1, respectively. The digital front-side signal SD1 also may be otherwise processed by the bottom circuit 23. The bottom circuit 23 also may otherwise process the digital back-side signal SD2, and outputs the digital front-side signal SD1 and the digital back-side signal SD2 in sequence.

The above-mentioned image-reading modules 11 and 21 may be CCD (Charge Coupled Device) or CIS (Contact Image Sensor) modules, wherein the CCD module is usually preferred. The bottom circuit 23 is usually designed as an application-specific integrated circuit (ASIC).

In this embodiment, each of the automatic document feeder 10 and the flatbed scanner 20 has a complete set of signal processing and control circuits, so the flatbed scanner 20 only has to receive the digital back-side signal SD2 that is processed and output from the automatic document feeder 10, and then to output the digital back-side signal SD2. Consequently, the above-mentioned design may effectively reduce the cost of the flatbed scanner 20. Preferably, the duplex scan operation is controlled after the top circuit 13 and the bottom circuit 23 are synchronized.

In addition to arranging a complete set of signal processing circuits in the automatic document feeder 10, it is also possible to selectively arranging some of the signal processing circuits in the automatic document feeder 10. The details will be described in the second and third embodiments.

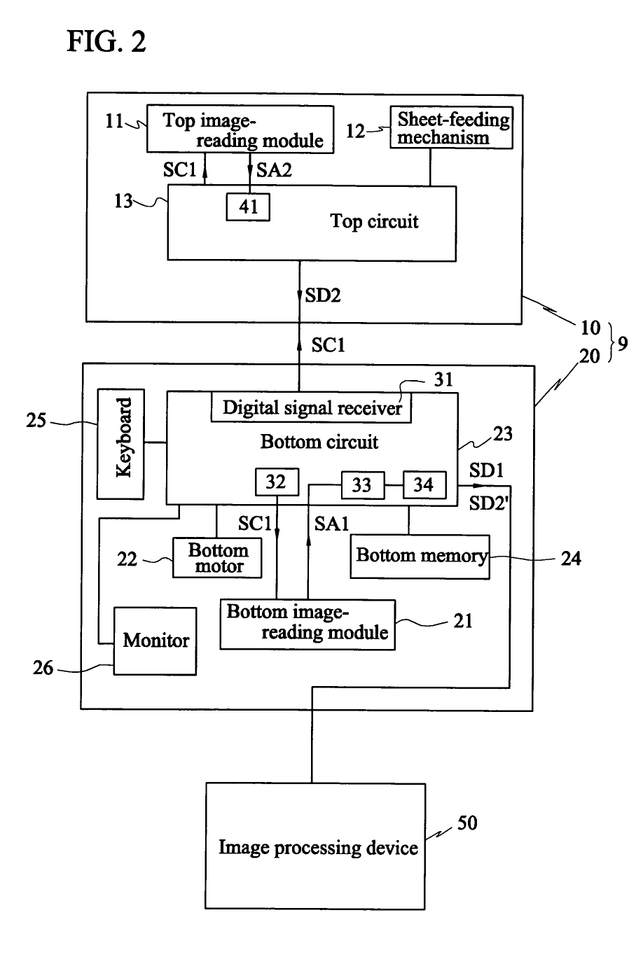

FIG. 2 is a block diagram showing a duplex scanner according to a second embodiment of the invention. This embodiment is similar to FIG. 1, but differs from FIG. 1 in that the top memory 14, the amplifier 42, and the clock generator 43 have been eliminated from the automatic document feeder 10. Thus, in addition to controlling the reading operations of the bottom image-reading module 21, the bottom clock signal SCI generated by the clock generator 32 is also transferred to the automatic document feeder 10 to control the reading operations of the top image-reading module 11. Furthermore, the top circuit 13 merely utilizes the analog-to-digital converter 41 to convert the analog back-side signal SA2 into the digital back-side signal SD2. The digital back-side signal SD2 is transferred to the bottom circuit 23 and is otherwise processed to produce a digital back-side signal SD2′. Finally, the digital front-side signal SD1 and the digital back-side signal SD2′ are output from the bottom circuit 23 to the image processing device 50.

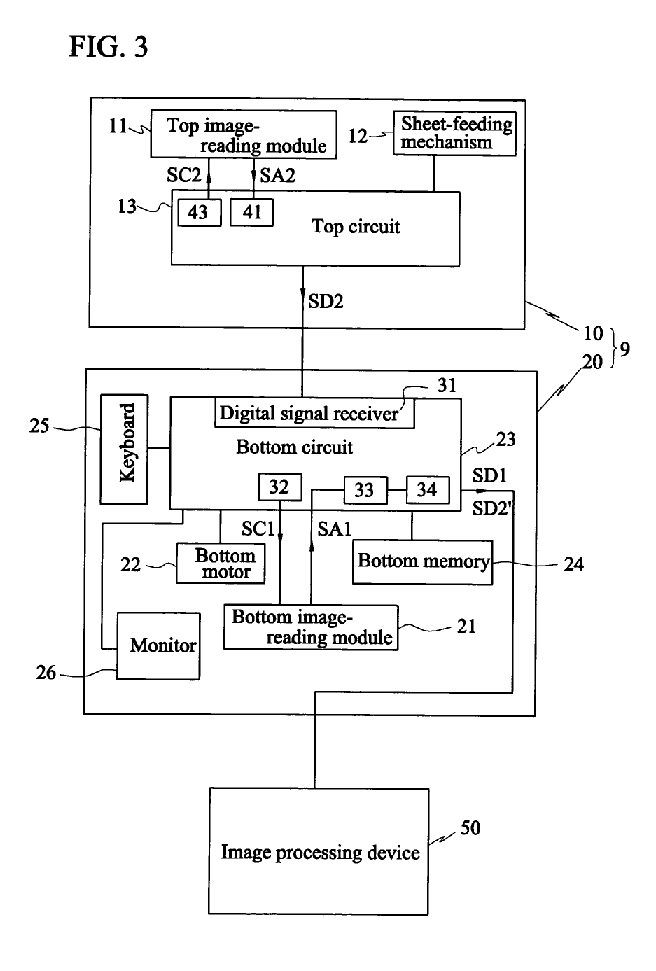

FIG. 3 is a block diagram showing a duplex scanner according to a third embodiment of the invention. This embodiment is similar to FIG. 1, but differs from FIG. 1 in that the top memory 14 and the amplifier 42 are eliminated from the automatic document feeder 10. Thus, the top circuit 13 merely utilizes the analog-to-digital converter 41 to convert the analog back-side signal SA2 into the digital back-side signal SD2. The digital back-side signal SD2 is transferred to the bottom circuit 23 and is otherwise processed to produce a digital back-side signal SD2′. Finally, the digital front-side signal SD1 and the digital back-side signal SD2′ are output from the bottom circuit 23 to the image processing device 50. Preferably, the duplex scan operation is controlled after the clock generator 43 and the clock generator 32 are synchronized.

Analog image signals are mainly transferred between the conventional automatic document feeder and the flatbed scanner. However, the automatic document feeder 10 of the invention may output digital image signals to the flatbed scanner 20, and the flatbed scanner 20 of the invention may receive the digital image signals from the automatic document feeder 10.

To sum up, the spirit of the invention is characterized in that the elements may be separately designed in the automatic document feeder and the flatbed scanner so that the elements of the flatbed scanner may be simplified and the cost thereof may be reduced. Consequently, when the user merely needs to perform flatbed scan operations or sheet-feeding and simplex scan operations, he or she needs not to buy an expensive, conventional flatbed scanner, which may be used in combination with a conventional automatic document feeder with the scan function to perform duplex scan operations. When the user needs a scanner to perform sheet-feeding and duplex scan operations, he or she only needs to buy the flatbed scanner of the invention and the automatic document feeder with the scan function, and the total costs are never higher than that of the prior art duplex scanner. Thus, the invention provides more elasticity for many users, and may effectively save the money for the user who has various requirements.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. A flatbed scanner, which may be used in combination with an automatic document feeder having a scan function to simultaneously scan a front side image and a back side image of a document, the flatbed scanner comprising:
a bottom image-reading module for reading the front side image to obtain an analog front-side signal;
a bottom motor for moving the bottom image-reading module;
a bottom circuit for controlling the bottom image-reading module and converting the analog front-side signal into a digital front-side signal; and
a bottom memory connected to the bottom circuit, wherein the bottom circuit comprises a digital signal receiver for receiving a digital back-side signal, which corresponds to the back side image, from the automatic document feeder.

2. The flatbed scanner according to claim 1, wherein the bottom circuit further comprises:
a clock generator for generating a bottom clock signal to control the bottom image-reading module; and
an analog-to-digital converter and an amplifier for converting and amplifying the analog front-side signal into the digital front-side signal, respectively.

3. The flatbed scanner according to claim 1, wherein the bottom clock signal is further transferred to the automatic document feeder.

4. The flatbed scanner according to claim 1, further comprising a keyboard through which a user may control operations of the flatbed scanner.

5. The flatbed scanner according to claim 1, further comprising a monitor for displaying a state of the flatbed scanner.

6. The flatbed scanner according to claim 1, wherein the bottom image-reading module is a CCD module or a CIS module.

7. The flatbed scanner according to claim 1, wherein the bottom circuit is an application-specific integrated circuit (ASIC).

8. An automatic document feeder, which may be used in combination with a flatbed scanner to simultaneously scan a back side image and a front side image of a document, the automatic document feeder comprising:
a top image-reading module for reading the back side image to obtain an analog back-side signal;
a sheet-feeding mechanism for feeding the document; and
a top circuit for receiving the analog back-side signal and converting the analog back-side signal into a digital back-side signal for output to the flatbed scanner.

9. The automatic document feeder according to claim 8, wherein the top image-reading module is a CCD module or a CIS module.

10. The automatic document feeder according to claim 8, wherein the top circuit comprises:
an analog-to-digital converter for converting the analog back-side signal into the digital back-side signal.

11. The automatic document feeder according to claim 8, further comprising a top memory connected to the top circuit, wherein the top circuit comprises an analog-to-digital converter and an amplifier for converting and amplifying the analog back-side signal into the digital back-side signal, respectively.

12. The automatic document feeder according to claim 8, wherein the top circuit comprises:
a clock generator for generating a top clock signal to control the top image-reading module; and
an analog-to-digital converter for converting the analog back-side signal into the digital back-side signal.

13. The automatic document feeder according to claim 8, wherein the top circuit comprises:
a clock generator for generating a top clock signal to control the top image-reading module; and
an analog-to-digital converter and an amplifier for converting and amplifying the analog back-side signal into the digital back-side signal, respectively.

14. A duplex scanner for simultaneously scanning a front side image and a back side image of a document, the duplex scanner comprising:
an automatic document feeder, comprising:
a top image-reading module for reading the back side image to obtain an analog back-side signal;
a sheet-feeding mechanism for feeding the document; and
a top circuit for controlling the top image-reading module and converting the analog back-side signal into a digital back-side signal for output; and
a flatbed scanner, comprising:
a bottom image-reading module for reading the front side image to obtain an analog front-side signal;
a bottom motor for moving the bottom image-reading module;
a bottom circuit for receiving the analog front-side signal and converting the analog front-side signal into a digital front-side signal; and
a bottom memory connected to the bottom circuit, wherein the bottom circuit comprises a digital signal receiver for receiving the digital back-side signal, which corresponds to the back side image, from the automatic document feeder.

15. The duplex scanner according to claim 14, wherein the top circuit comprises an analog-to-digital converter for converting the analog back-side signal into the digital back-side signal, and the bottom circuit further comprises:
a clock generator for generating a bottom clock signal to control the bottom image-reading module and the top image-reading module; and
an analog-to-digital converter and an amplifier for converting and amplifying the analog front-side signal into the digital front-side signal, respectively, and the amplifier further amplifying the digital back-side signal.

16. The duplex scanner according to claim 14, wherein:
the automatic document feeder further comprises a top memory connected to the top circuit;
the top circuit comprises an analog-to-digital converter and an amplifier for converting and amplifying the analog back-side signal into the digital back-side signal, respectively; and
the bottom circuit comprises:
a clock generator for generating a bottom clock signal to control the bottom image-reading module and the top image-reading module; and
an analog-to-digital converter and an amplifier for converting and amplifying the analog front-side signal into the digital front-side signal, respectively.

17. The duplex scanner according to claim 14, wherein the top circuit comprises:
an analog-to-digital converter and an amplifier for converting and amplifying the analog back-side signal into the digital back-side signal, respectively; and
a clock generator for generating a top clock signal to control the top image-reading module; and
the bottom circuit comprises:
a clock generator for generating a bottom clock signal to control the bottom image-reading module; and
an analog-to-digital converter and an amplifier for converting and amplifying the analog front-side signal into the digital front-side signal, respectively.

18. The duplex scanner according to claim 17, wherein the automatic document feeder further comprises a top memory connected to the top circuit.

19. The duplex scanner according to claim 14, wherein each of the top image-reading modules is a CCD module or a CIS module.

20. The duplex scanner according to claim 14, wherein each of the bottom image-reading modules is a CCD module or a CIS module.
